(19) United States
(12) Patent Application Publication
(10) Pub. No.: US 2012/0036583 A1
(43) Pub. Date: Feb. 9, 2012

(54) COMPUTER READABLE MEDIUM STORING PROGRAM, INFORMATION PROCESSING APPARATUS, AND METHOD

(75) Inventor: Tomohiro KICHIKAWA, Kanagawa (JP)

(73) Assignee: FUJI XEROX CO., LTD., Tokyo (JP)

(21) Appl. No.: 13/034,471

(22) Filed: Feb. 24, 2011

(30) Foreign Application Priority Data
Aug. 4, 2010 (JP) 2010-175081

(51) Int. Cl. G06F 21/00

(52) U.S. Cl. 726/27

(57) ABSTRACT

A computer readable medium stores a program for controlling access to electronically stored information. The program causes a computer to execute a process including receiving first user information indicating a first user who performs an operation of changing an access right, second user information indicating a second user having the access right, and operation information indicating the operation; extracting grantor information corresponding to grantee information representing the second user information from access right grantor/grantee correspondence information in which grantor information indicating a grantor who has granted an access right to perform an operation on information is related to grantee information indicating a grantee granted the access right by the grantor; determining whether or not the extracted grantor information represents the first user information; and changing the access right indicated by the operation information if it is determined that the extracted grantor information represents the received first user information.

### CROSS-REFERENCE TO RELATED APPLICATIONS

This application is based on and claims priority under 35 USC 119 from Japanese Patent Application No. 2010-175081 filed Aug. 4, 2010.

### BACKGROUND

(i) Technical Field

The present invention relates to a computer readable medium storing a program, an information processing apparatus, and a method.

(ii) Related Art

Techniques for controlling access rights for information have been available.

### SUMMARY

According to an aspect of the invention, there is provided a computer readable medium storing a program for controlling access to electronically stored information. The program causes a computer to execute a process including receiving first user information indicating a first user who performs an operation of changing an access right, second user information indicating a second user having the access right to be changed, and operation information indicating the operation of changing the access right; extracting, from access right grantor/grantee correspondence information stored in a storage device, grantor information corresponding to grantee information representing the received second user information, the access right grantor/grantee correspondence information being information in which grantor information indicating a grantor who has granted an access right to perform an operation on information is related to grantee information indicating a grantee granted the access right by the grantor; determining whether or not the extracted grantor information represents the received first user information; and performing a process for changing the access right indicated by the received operation information if it is determined that the extracted grantor information represents the received first user information.

### BRIEF DESCRIPTION OF THE DRAWINGS

Exemplary embodiment(s) of the present invention will be described in detail based on the following figures, wherein:

FIG. 1 is a conceptual module configuration diagram of an example configuration of an exemplary embodiment;

FIG. 2 is a flowchart illustrating an example process performed by an access control list change content determination module according to the exemplary embodiment;

FIG. 3 is a flowchart illustrating an example process performed by a superiority relationship information generation-A module according to the exemplary embodiment;

FIG. 4 is a flowchart illustrating an example process performed by a superiority relationship determination module according to the exemplary embodiment;

FIG. 5 is a flowchart illustrating an example process performed by an object storage module according to the exemplary embodiment;

FIG. 6 illustrates an example association (1) between an object, an access control list, and superiority relationship information;

FIG. 7 illustrates an example association (2) between an object, an access control list, and superiority relationship information;

FIG. 8 illustrates an example data structure of an operation history table;

FIG. 9 illustrates an example data structure of an access control list;

FIG. 10 illustrates an example relationship between an access right grantor and an access right grantee;

FIG. 11 illustrates an example data structure of an object storage information table;

FIG. 12 illustrates an example data structure of an access control list;

FIG. 13 illustrates an example data structure of a superiority relationship information table;

FIG. 14 illustrates an example data structure of an object storage information table;

FIG. 15 illustrates an example data structure of an access control list change history table; and

FIG. 16 is a block diagram illustrating an example hardware configuration of a computer according to the exemplary embodiment.

### DETAILED DESCRIPTION

Examples of an exemplary embodiment of the present invention will be described hereinafter with reference to the drawings.

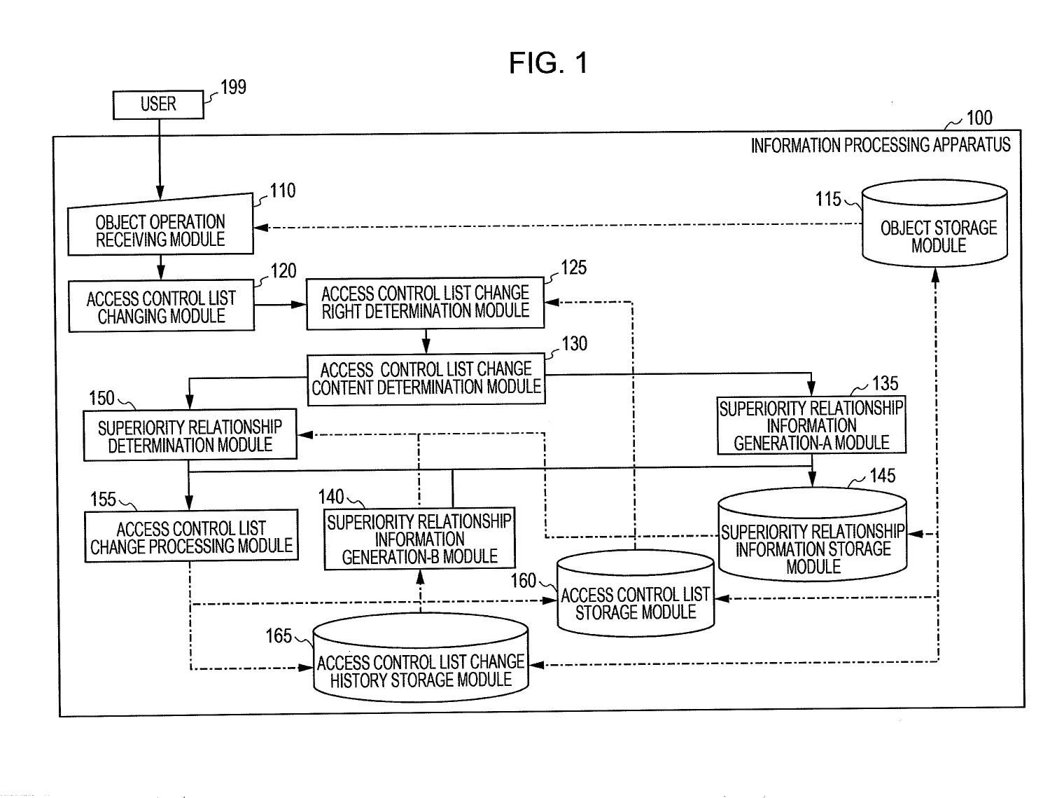

FIG. 1 is a conceptual module configuration diagram of an example configuration of the exemplary embodiment.

The term “module” generally refers to a logically separable part of software (computer program), hardware, or the like. Therefore, the term “module” as used in this exemplary embodiment refers to not only a module in a computer program but also a module in a hardware configuration. Thus, this exemplary embodiment will be described in the context of a computer program for providing functions of modules (a program for causing a computer to execute individual procedures, a program for causing a computer to function as individual functions, a program for causing a computer to realize individual functions), a system, and a method. While “storing”, “being stored”, and equivalent terms are used for convenience of description, such terms indicate, when the exemplary embodiment relates to a computer program, storing of the computer program in a storage device or performing of control to store the computer program in a storage device. Furthermore, modules and functions may have a one-to-one correspondence. In terms of implementation, one module may be composed of one program, plural modules may be composed of one program, or, conversely, one module may be composed of plural programs. Additionally, plural modules may be executed by a single computer, or a single module may be executed by plural computers in a distributed or parallel environment. One module may include another module. Further, hereinafter, the term “connection” includes physical connection and logical connection (such as exchanging data, issuing an instruction, and cross-reference between data items). The term “predetermined” means “determined before” the performance of a desired process, and may include “determined before” the start of a process according to the exemplary embodiment, and “determined before” the performance of a desired process even after the start of a process according to the exemplary embodiment, in accordance with the current state and condition or in accordance with the previous state and condition.

Furthermore, the term “system or apparatus” includes a configuration in which plural computers, hardware components, devices, or other suitable elements are connected to one another via a communication medium such as a network (including a one-to-one communication connection), and what is implemented by a single computer, hardware component, device, or suitable element. The terms “apparatus” and “system” are used as synonymously. It is to be understood that the term “system” does not include what is merely a social “mechanism” (social system) based on artificial rules.

Moreover, desired information is read from a storage device for each process performed by an individual module or, if plural processes are performed within a module, for each of the plural processes, and is processed. The process result is written in the storage device. Therefore, reading information from the storage device before processing the information and writing information to the storage device after processing the information may not necessarily be described herein. The term “storage device”, as used herein, may include a hard disk, a random access memory (RAM), an external storage medium, a storage device using a communication line, and a register in a central processing unit (CPU).

An information processing apparatus 100 according to this exemplary embodiment is configured to allow a first user to grant an access right for information to a second user or change an access right of the second user for the information. As illustrated in an example in FIG. 1, the information processing apparatus 100 includes an object operation receiving module 110, an object storage module 115, an access control list changing module 120, an access control list change access right determination module 125, an access control list change content determination module 130, a superiority relationship information generation-A module 135, a superiority relationship information generation-B module 140, a superiority relationship information storage module 145, a superiority relationship determination module 150, an access control list change processing module 155, an access control list storage module 160, and an access control list change history storage module 165. In the example illustrated in FIG. 1, solid lines indicating directions are drawn between modules to indicate that a process requester has requested a process executor to perform a process. That is, in accordance with a request from a module indicated by an arrow tail, a module indicated by an arrow head performs a process. Further, in the example illustrated in FIG. 1, dotted lines indicating directions are drawn between modules to indicate that data moves from a data movement source to a data movement destination. That is, data moves from a module indicated by an arrow tail to a module indicated by an arrow head.

The object operation receiving module 110 is connected to the object storage module 115 and the access control list changing module 120. The object operation receiving module 110 receives first user information indicating a user 199 (first user) who performs an operation of changing a right, second user information indicating a second user whose right is changed, and operation information indicating the operation of changing the right in accordance with an operation performed by the user 199. The object operation receiving module 110 may not necessarily simultaneously receive all the first user information, the second user information, and the operation information. For example, the object operation receiving module 110 may receive first user information when the user 199 logs in to the information processing apparatus 100, or may read, using a card reader, first user information stored in an integrated circuit (IC) card owned by the user 199. Then, the second user information and the operation information may be received by the right changing operation performed by the user 199. A user who has a right (hereinafter also referred to as an “access right”) for information is authorized to perform operations (such as viewing, editing, and deletion) the user is permitted by the right to perform on the information.

The object operation receiving module 110 may also receive third user information indicating a user 199 (third user) who performs an operation of granting a right, user information indicating a fourth user who is granted the right, and operation information indicating the operation of granting the right in accordance with an operation performed by the user 199.

The second user whose right is changed and the fourth user who is granted a right may be individual persons or groups of multiple users.

The object operation receiving module 110 may also receive operations such as registering, obtaining, and changing information stored in the object storage module 115, granting a right for the information, and changing a right for the information. The object operation receiving module 110 passes information regarding the operations of granting a right and changing a right among received operations to the access control list changing module 120.

The object storage module 115 is connected to the object operation receiving module 110, the superiority relationship information storage module 145, the access control list storage module 160, and the access control list change history storage module 165. The object storage module 115 includes a storage device, and stores information (hereinafter also referred to as an “object”) on documents and the like. More specifically, the object storage module 115 stores an object, an identifier of an access control list associated with the object, an identifier of information on the correspondence between a grantor who grants a right and a grantee granted the right (the information is hereinafter referred to as “right grantor/grantee correspondence information” or also referred to as “superiority relationship information”), and any other suitable items. The object storage module 115 may also be configured to obtain right grantor/grantee correspondence information used for the determination of access rights for an object from the object. For example, objects and right grantor/grantee correspondence information may be stored in association with each other, and right grantor/grantee correspondence information may be obtained on the basis of the association (which will be described below with reference to FIG. 6). Also, objects and access control lists may be stored in association with each other, and the access control lists and right grantor/grantee correspondence information may be stored in association with each other. Right grantor/grantee correspondence information may be obtained from an access control list associated with an object (which will be described below with reference to FIG. 7).

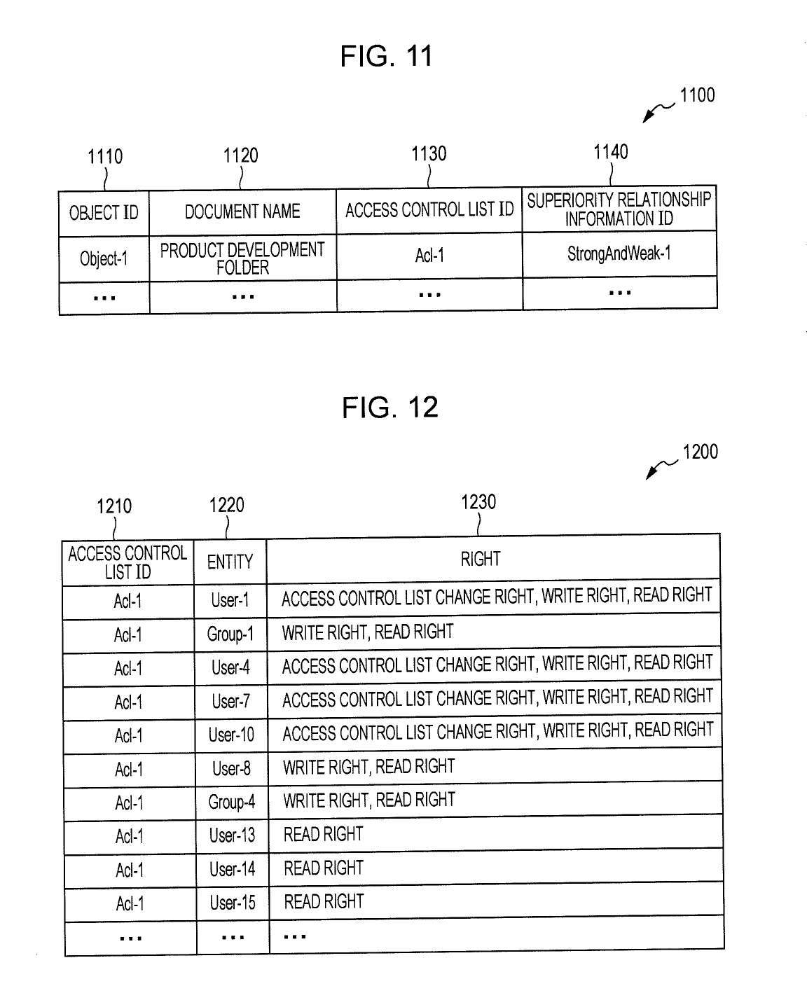

Data stored in the object storage module 115 will be described below with reference to FIGS. 11 and 14.

The access control list changing module 120 is connected to the object operation receiving module 110 and the access control list change right determination module 125. In accordance with the right grant or change operation received by the object operation receiving module 110, the access control list changing module 120 controls other modules to perform a process for granting or changing a right. For example, specifically, the access control list changing module 120 performs a right grant or change process on an access control list (ACL) described below.

The access control list change right determination module 125 is connected to the access control list changing module 120, the access control list change content determination module 130, and the access control list storage module 160. The access control list change right determination module 125 determines whether or not a person who changes an access right (hereinafter referred to as an “access right changer” or a “changer”) (first user or third user) is granted the right to change an access right for a specified object, by obtaining an access control list for the object from the access control list storage module 160.

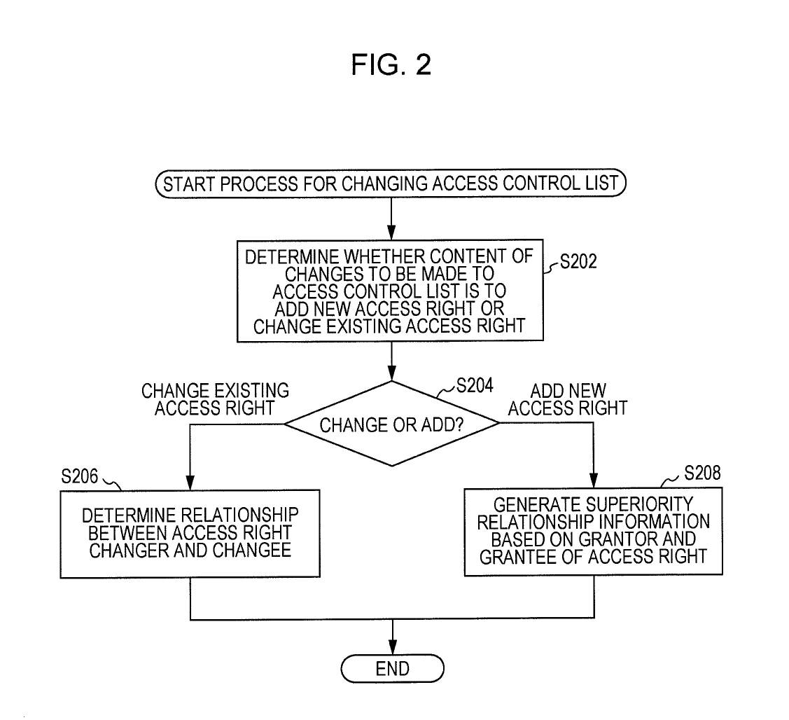

The access control list change content determination module 130 is connected to the access control list change right determination module 125, the superiority relationship information generation-A module 135, and the superiority relationship determination module 150. The access control list change content determination module 130 determines the content of changes to be made to an access right. If a new access right is to be added, the access control list change content determination module 130 advances the process to the superiority relationship information generation-A module 135 to generate superiority relationship information. If an existing access right is to be changed, the access control list change content determination module 130 advances the process to the superiority relationship determination module 150 to perform a process for determining the superior-subordinate relationship. The process performed by the access control list change content determination module 130 will be described below with reference to FIG. 2.

The superiority relationship information generation-A module 135 and the superiority relationship information generation-B module 140 generate right grantor/grantee correspondence information containing grantors and grantees of access rights.

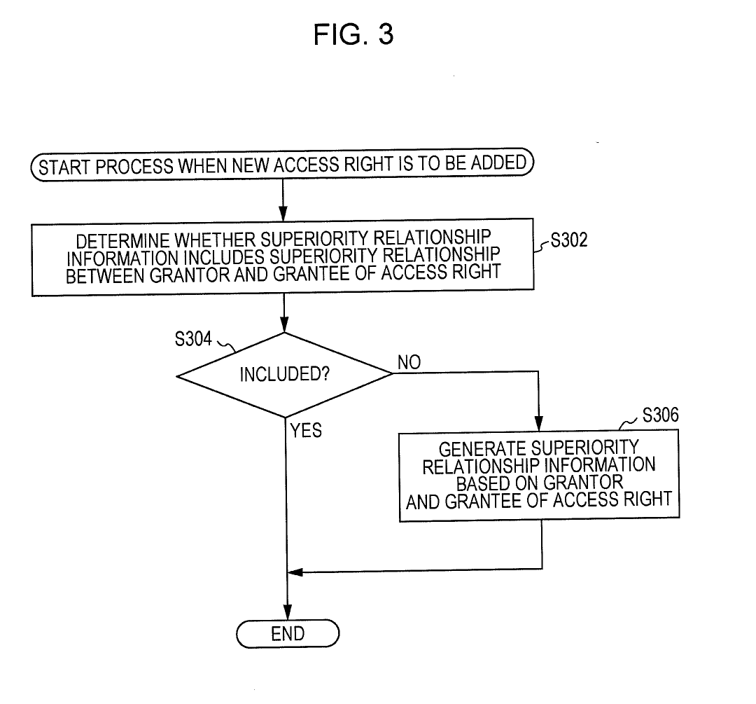

The superiority relationship information generation-A module 135 is connected to the access control list change content determination module 130, the superiority relationship information storage module 145, and the access control list change processing module 155. The superiority relationship information generation-A module 135 generates right grantor/grantee correspondence information to be stored in the superiority relationship information storage module 145 using, as grantor information, third user information received by the object operation receiving module 110 and using, as grantee information, fourth user information received by the object operation receiving module 110. The generated right grantor/grantee correspondence information is stored in the superiority relationship information storage module 145. The process performed by the superiority relationship information generation-A module 135 will be described below with reference to FIG. 3.

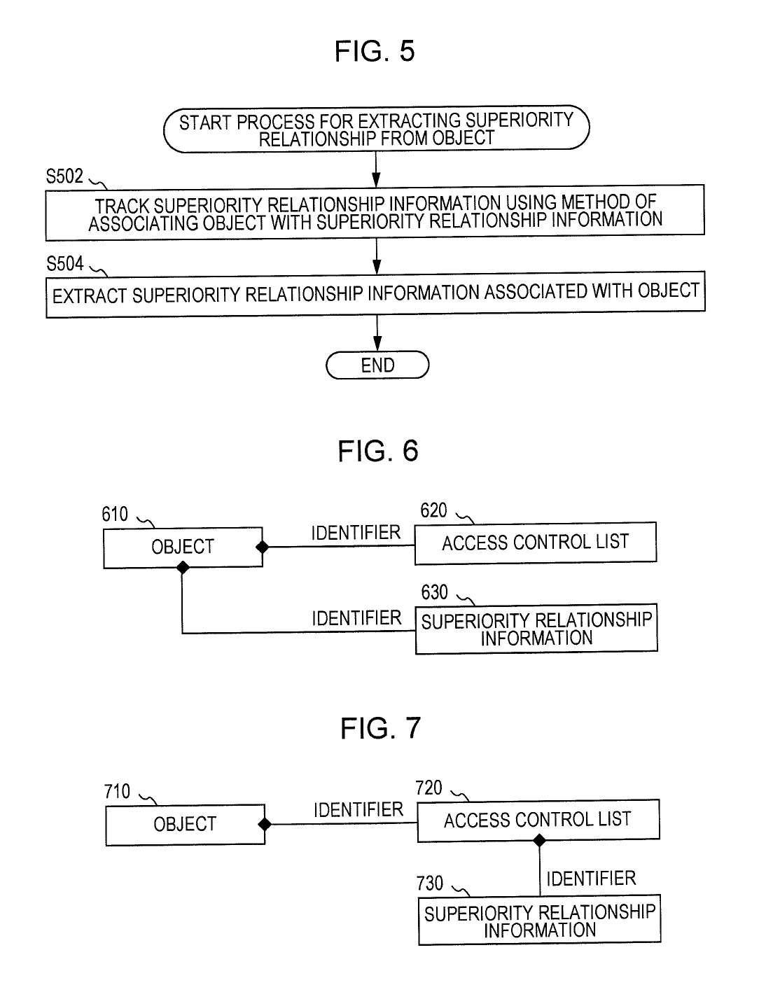

The superiority relationship information generation-B module 140 is connected to the superiority relationship determination module 150, the access control list change history storage module 165, and the superiority relationship information storage module 145. The superiority relationship information generation-B module 140 generates right grantor/grantee correspondence information from history information stored in the access control list change history storage module 165, using third user information in the history information as grantor information and using fourth user information in the history information as grantee information. The generated right grantor/grantee correspondence information is stored in the superiority relationship information storage module 145. The process performed by the superiority relationship information generation-B module 140 will be described below with reference to FIG. 5.

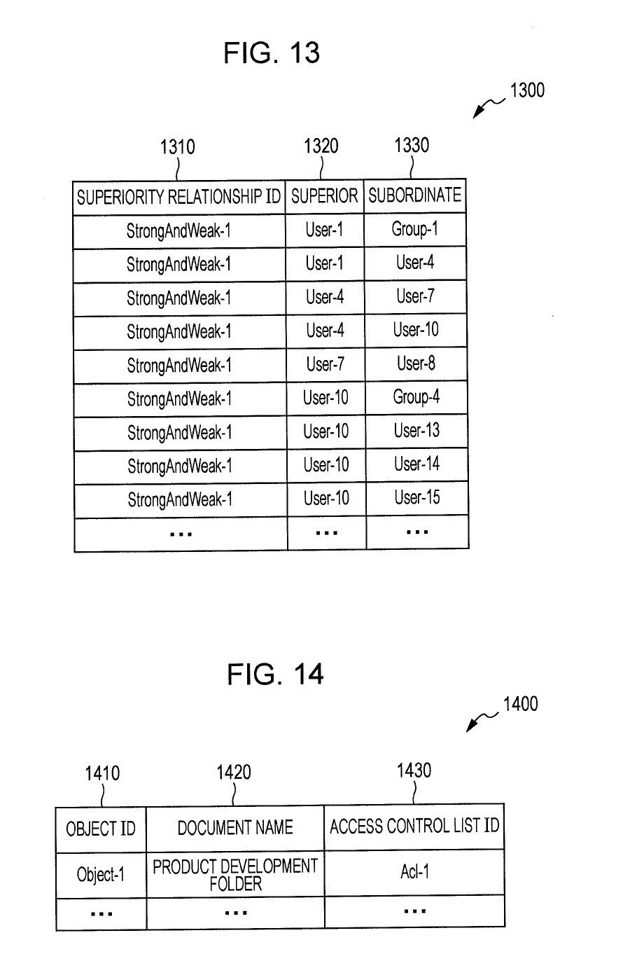

The superiority relationship information storage module 145 is connected to the object storage module 115, the superiority relationship information generation-A module 135, the superiority relationship information generation-B module 140, and the superiority relationship determination module 150. The superiority relationship information storage module 145 includes a storage device, and stores, in the storage device, right grantor/grantee correspondence information in which grantor information indicating a grantor who has granted a right to perform an operation on information is related to grantee information indicating a grantee granted the right by the grantor. Right grantor/grantee correspondence information including plural correspondences between grantors and grantees may also be used. Data stored in the superiority relationship information storage module 145 will be described below with reference to FIG. 13.

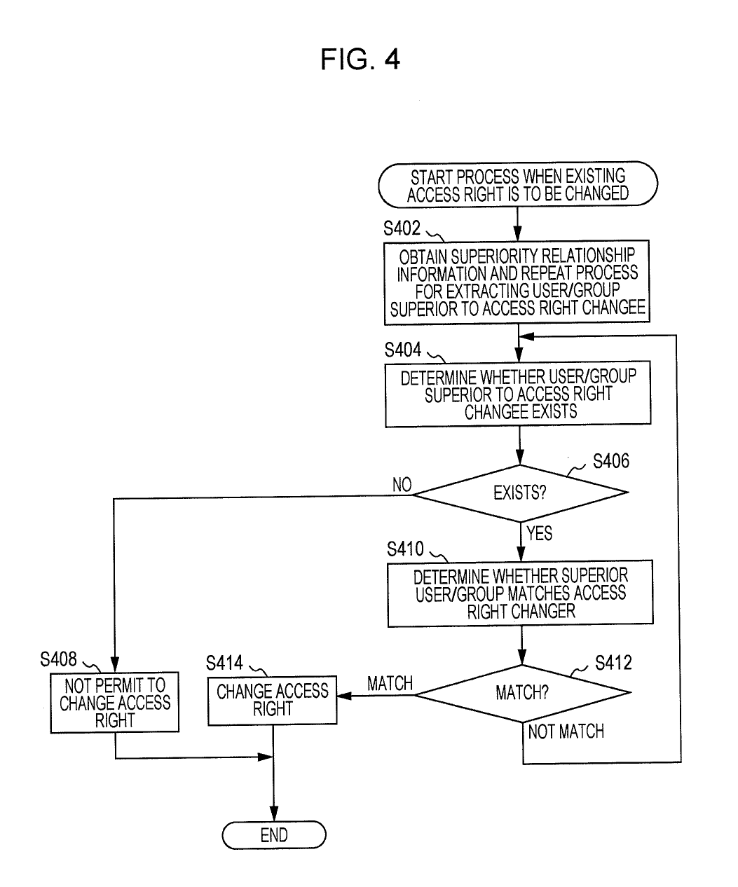

The superiority relationship determination module 150 is connected to the access control list change content determination module 130, the superiority relationship information generation-B module 140, the superiority relationship information storage module 145, and the access control list change processing module 155. The superiority relationship determination module 150 extracts grantor information corresponding to grantee information representing second user information received by the object operation receiving module 110 from the right grantor/grantee correspondence information in the superiority relationship information storage module 145. Then, the superiority relationship determination module 150 determines whether or not the extracted grantor information represents first user information received by the object operation receiving module 110. The process performed by the superiority relationship determination module 150 will be described below with reference to FIG. 4.

If it is determined in the above determination process that the extracted grantor information does not represent the first user information, the superiority relationship determination module 150 may extract grantor information related to the grantee information corresponding to the previous grantor information extracted in the above extraction process from the right grantor/grantee correspondence information in the superiority relationship information storage module 145.

The access control list change processing module 155 is connected to the superiority relationship information generation-A module 135, the superiority relationship determination module 150, the access control list storage module 160, and the access control list change history storage module 165. If the superiority relationship determination module 150 determines that the extracted grantor information represents the first user information, the access control list change processing module 155 performs a process for changing the right specified by the operation information received by the object operation receiving module 110. The access control list obtained after the right change process is stored in the access control list storage module 160, and the access right changer and the content of the changes made to the access control list are stored in the access control list change history storage module 165.

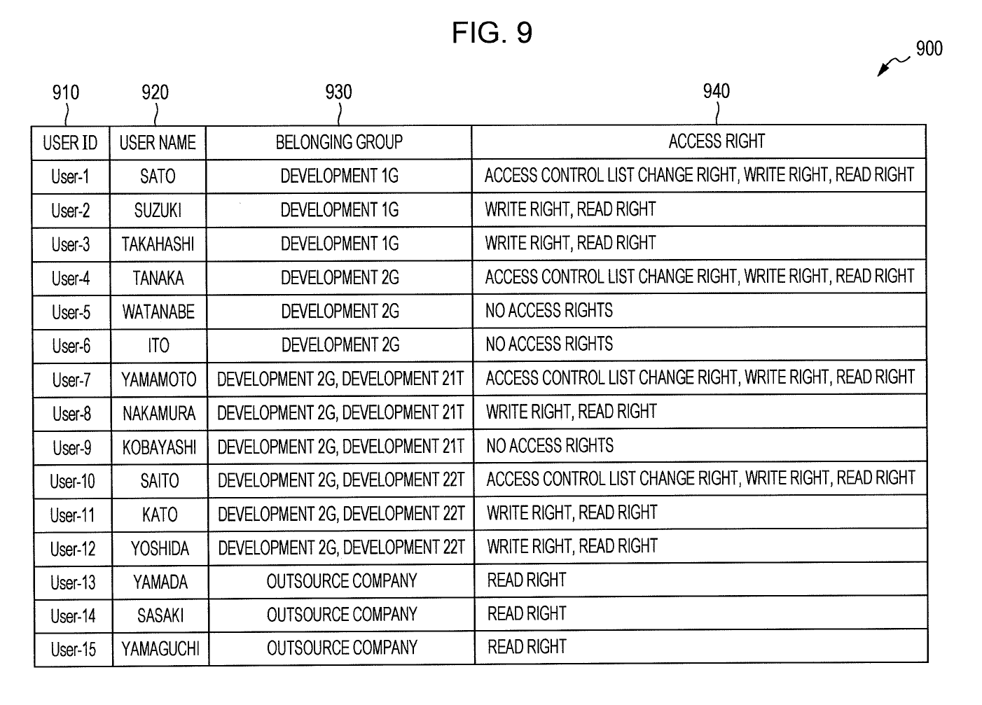

The access control list storage module 160 is connected to the object storage module 115, the access control list change right determination module 125, and the access control list change processing module 155. The access control list storage module 160 includes a storage device, and stores an access control list. Data stored in the access control list storage module 160 will be described below with reference to FIGS. 9 and 12.

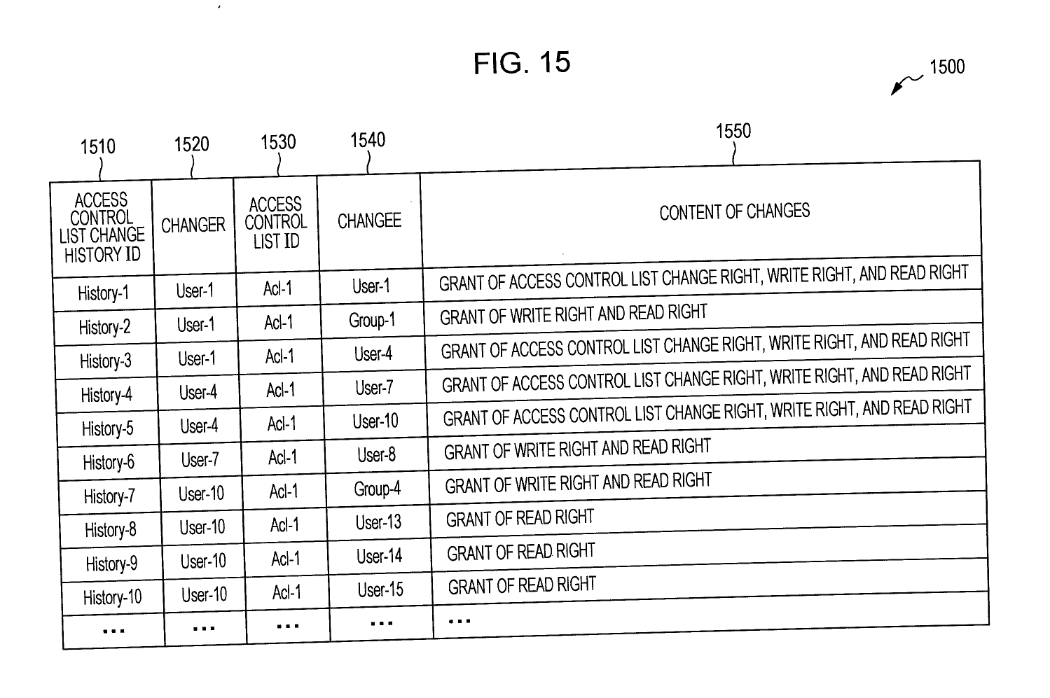

The access control list change history storage module 165 is connected to the object storage module 115, the superiority relationship information generation-B module 140, and the access control list change processing module 155. The access control list change history storage module 165 includes a storage device, and stores, in the storage device, history information including the history of previously granted rights, that is, information in which third user information indicating third users who have granted the rights is related to fourth user information indicating fourth users to which the rights have been set by the third users. Specifically, for example, the access control list change history storage module 165 stores the history of changes made to an access control list, including an access right changer (third user), an identifier of an access control list to which changes have been made, a person having the access right to be changed (hereinafter referred to as an “access right changee” or a “changee”) (fourth user), and the content of the changes. Data stored in the access control list change history storage module 165 will be described below with reference to FIG. 15.

FIG. 2 is a flowchart illustrating an example process performed by the access control list change content determination module 130 according to this exemplary embodiment. This process may be a process for making changes to an access control list, and it is determined whether or not the operation information received by the object operation receiving module 110 is to change an access right or grant (add) an access right.

In step S202, the content of the changes to be made to an access control list (operation information received by the object operation receiving module 110) is to add a new access right or change an existing access right.

If it is determined in step S204 through the processing of step S202 that an existing access right is to be changed, the process proceeds to step S206. If it is determined that a new access right is to be added, the process proceeds to step S208.

In step S206, the superiority relationship determination module 150 determines the relationship between an access right changer and an access right changee on the basis of superiority relationship information. The processing of step S206 will be described below with reference to FIG. 4.

In step S208, the superiority relationship information generation-A module 135 generates superiority relationship information on the basis of the grantor and grantee of the access right. The processing of step S208 will be described below with reference to FIG. 3.

FIG. 3 is a flowchart illustrating an example process performed by the superiority relationship information generation-A module 135 according to this exemplary embodiment. This process may be a process performed when a new access right is to be added, and also a process for generating superiority relationship information.

In step S302, it is determined whether or not superiority relationship information includes the superiority relationship between the grantor and grantee of the access right. That is, it is determined whether or not superiority relationship information contains a correspondence between the grantor and the grantee. If the superiority relationship is not included, the correspondence is stored (step S306). If the superiority relationship is included, the process ends without storing any further information.

If it is determined in step S304 through the processing of step S302 that the superiority relationship is included, the process ends. Otherwise, the process proceeds to step S306.

In step S306, superiority relationship information is generated on the basis of the grantor and grantee of the access right.

FIG. 4 is a flowchart illustrating an example process performed by the superiority relationship determination module 150 according to this exemplary embodiment. This process may be a process performed when an existing access right is to be changed, and it is determined, using superiority relationship information, whether or not changing the existing access right is permissible.

In step S402, superiority relationship information is obtained, and a process for extracting a user/group superior to the access right changee (second user) (the processing of step S404 and the subsequent processing) is repeatedly performed. The term “superior user/group” refers to the grantor of the access right if an access right grantor-grantee relationship is established. A specific example of the processing of step S402 will be described below with reference to FIG. 13.

In step S404, it is determined whether or not a user/group superior to the access right changee exists.

If it is determined in step S406 through the processing of step S404 that a superior user/group exists, the process proceeds to step S410. Otherwise, the process proceeds to step S408.

In step S408, changing the access right is not permitted.

In step S410, it is determined whether or not the superior user/group matches the access right changer (first user).

If it is determined in step S412 through the processing of step S410 that both match, the process proceeds to step S414. Otherwise, the process proceeds to the process from step S404.

In step S414, the access right is changed.

FIG. 5 is a flowchart illustrating an example process performed by the object storage module 115 according to this exemplary embodiment. This process may be a process for obtaining superiority relationship from an object. Superiority relationship information may be used when an access right is to be changed, that is, when the process illustrated by way of example in FIG. 4 is performed. Thus, superiority relationship information associated with the object for which the access right is to be changed is extracted.

In step S502, superiority relationship information is tracked using a method for associating the object with the superiority relationship information. Examples of the association between an object and superiority relationship information are illustrated in FIGS. 6 and 7.

FIG. 6 illustrates an example association (1) between an object 610, an access control list 620, and superiority relationship information 630.

The object 610 is associated with the access control list 620 and the information 630. For example, management information on the object 610 includes an identifier uniquely identifying the access control list 620 and an identifier uniquely identifying the superiority relationship information 630. The object storage module 115 tracks the superiority relationship information 630 using the identifier of the superiority relationship information 630 included in the management information on the object 610.

FIG. 7 illustrates an example association (2) between an object 710, an access control list 720, and superiority relationship information 730.

The object 710 is associated with the access control list 720, and the access control list 720 is associated with the superiority relationship information 730. For example, management information on the object 710 includes an identifier uniquely identifying the access control list 720, and management information on the access control list 720 includes an identifier uniquely identifying the superiority relationship information 730. The object storage module 115 extracts the access control list 720 using the identifier of the access control list 720 included in the management information on the object 710, and further tracks the superiority relationship information 730 using the identifier of the superiority relationship information 730 included in the management information on the access control list 720.

In step S504, superiority relationship information associated with the object is extracted.

The superiority relationship will now be described using a specific example. It is assumed that, by way of example, the object operation receiving module 110 creates a product development folder (object) to be used for a product development project, and sets access rights to individual groups given by way of example in Table 1. Five groups are found, which have relationships given by way of example in the description of Table 1.

TABLE 1

| Group ID | Group Name | Description |
|---|---|---|
| Group-1 | Development | Group that is the first in charge of |
| | 1G | the product development project: All |
| | | the group members take part in product |
| | | development. |
| Group-2 | Development | Group that is the second in charge of |
| | 2G | the product development project: Some |
| | | of the group members take part in |
| | | product development. |
| Group-3 | Development | Team belonging to Development 2G: Some |
| | 21T | of the team members take part in |
| | | product development. |
| Group-4 | Development | Team belonging to Development 2G: All |
| | 22T | the team members take part in product |
| | | development. |
| Group-5 | Outsource | Group contracted by Development 22T to |
| | Company | support the development of the product |
| | | development project: Some of the group |
| | | members take part in the development |
| | | support. |

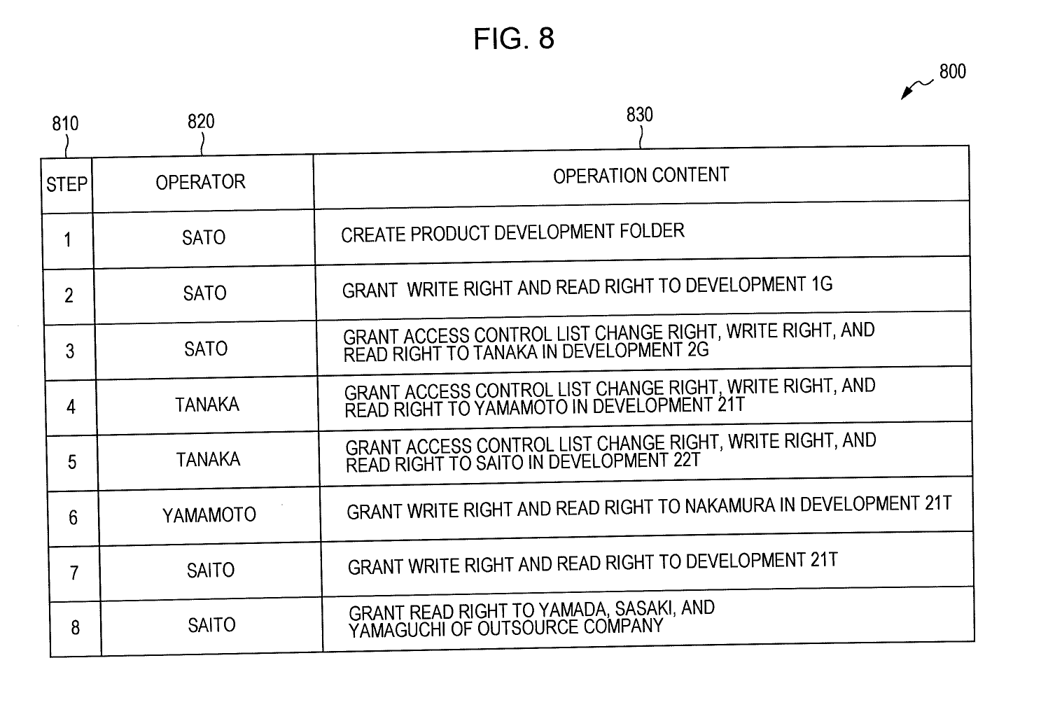

It is assumed that, by way of example, operations illustrated by way of example in FIG. 8 have been performed on the product development folder, and access rights illustrated by way of example in FIG. 9 have been granted. An operation history table 800 illustrated by way of example in FIG. 8 is stored in the access control list change history storage module 165. A more detailed example will be described below with reference to FIG. 15. An access control list 900 illustrated by way of example in FIG. 9 is stored in the access control list storage module 160. A more detailed example will be described below with reference to FIG. 12.

FIG. 8 illustrates an example data structure of the operation history table 800. The operation history table 800 includes a STEP column 810, an OPERATOR column 820, and an OPERATION CONTENT column 830. The STEP column 810 stores the order of a process such as a grant of an access right. The OPERATOR column 820 stores a user who has performed an operation. The OPERATION CONTENT column 830 stores the content of an operation that has been performed. For example, in step 1, “Sato” creates a product development folder. In step 2, “Sato” grants access rights, namely, the write right and the read right, to Development 1G.

FIG. 9 illustrates an example data structure of the access control list 900. The access control list 900 includes a USER ID column 910, a USER NAME column 920, a BELONGING GROUP column 930, and an ACCESS RIGHT column 940. The USER ID column 910 stores a user ID uniquely identifying a user. The USER NAME column 920 stores a user name identified by the user ID. The BELONGING GROUP column 930 stores a group to which the user belongs. The ACCESS RIGHT column 940 stores an access right granted to the user for the product development folder.

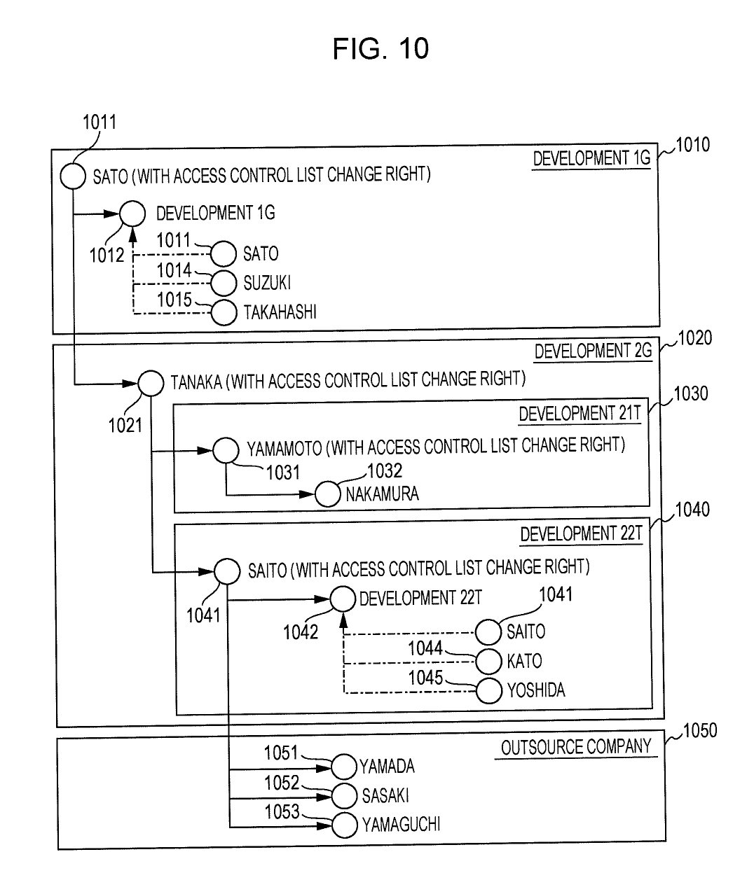

FIG. 10 illustrates an example relationship between the grantor and grantee of an access right. In FIG. 10, a representation of the example relationships in the operation history table 800 in FIG. 8 is illustrated. That is, “Sato (with the access control list change right)” 1011 grants the write right and the read right to “Development 1G” 1012 (step 2 in the operation history table 800). Members of “Development 1G” 1012 include “Sato (with the access control list change right)” 1011, “Suzuki” 1014, and “Takahashi” 1015. “Sato (with the access control list change right)” 1011 grants the access control list change right (which may be the right to change an access control list itself), the write right, and the read right to “Tanaka (with the access control list change right)” 1021 in “Development 2G” 1020 (step 3 in the operation history table 800). “Tanaka (with the access control list change right)” 1021 grants the access control list change right, the write right, and the read right to “Yamamoto (with the access control list change right)” 1031 in “Development 21T” 1030 (step 4 in the operation history table 800). The example relationships in the operation history table 800 are illustrated in the manner as above.

As described above in the description of the groups in Table 1, (A) a first-second-in-charge relationship is established between “Development 1G” and “Development 2G”, (B) organizational hierarchical relationships are established between “Development 2G” and “Development 21T” and between “Development 2G” and “Development 22T”, and (C) an outsourcer-outsourcee relationship is established between “Development 22T” and the outsource company. Superiority relationships between superior entities (first-in-charge, high rank in the organization, and outsourcer) and subordinate entities (second-in-charge, low rank in the organization, and outsourcee) may be based on the abstraction of the above plural relationships.

However, the following difficulties may occur. The users granted the access control list change right for the product development folder, i.e., “Sato (with the access control list change right)” 1011, “Tanaka (with the access control list change right)” 1021, “Yamamoto (with the access control list change right)” 1031, and “Saito (with the access control list change right)” 1041, may be able to change access rights of users/groups while ignoring the above superiority relationships. In this situation, for example, “Tanaka (with the access control list change right)” 1021 is able to change the access right of “Development 1G” 1012 which has been added by “Sato (with the access control list change right)” 1011 (first-in-charge) superior to “Tanaka (with the access control list change right)” 1021 (second-in-charge). The equivalent may also apply to the relationship between “Yamamoto (with the access control list change right)” 1031 and “Tanaka (with the access control list change right)” 1021 and the relationship between “Saito (with the access control list change right)” 1041 and “Tanaka (with the access control list change right)” 1021. Further, if it is assumed that a certain user is only allowed to manage access rights in the range of users/groups subordinate to the certain user (second-in-charge, lower rank in the organization, and outsourcee), “Yamamoto (with the access control list change right)” 1031 is able to change the access rights of “Development 22T” 1042, “Yamada” 1051, “Sasaki” 1052, and “Yamaguchi” 1053, which have been added by “Saito (with the access control list change right)” 1041 having no superiority relationship with “Yamamoto (with the access control list change right)” 1031, beyond the control range.

In order to address the above difficulties, it may be necessary to create superiority relationship information reflecting the relationship between the grantor and grantee of an access right and to reflect the superiority relationship information in the change of an access right (here, the superiority relationship information is not limited to only an organizational hierarchical relationship).

As illustrated by way of example in FIG. 10, a superiority relationship, i.e., superior-subordinate (adder-addee) relationship, is also established between an access right grantor and grantee, which may resemble the above relationships (such as a first-second-in-charge relationship, an organizational hierarchical relationship, and an outsourcer-outsourcee relationship). In this exemplary embodiment, therefore, the relationship between the grantor and grantee of an access right is used as superiority relationship information. That is, when a new access right is to be added to an object, superiority relationship information is created. When an existing access right is to be changed, the relationship between the access right changer and the access right changee is determined from the superiority relationship information obtained from the object, and access control is performed to determine whether or not changing the access right is permissible.

In the following description, by way of example, access rights are granted to users (individual users or groups) given by way of example in Table 1 and FIG. 9 through the operations illustrated by way of example in FIG. 8 on the product development folder described above.

<1> A description will be given of a case where when a new access right is added, superiority relationship information is created and is stored in the superiority relationship information storage module 145.

FIG. 11 illustrates an example data structure of an object storage information table 1100. The object storage information table 1100 is stored in the object storage module 115. The object storage information table 1100 includes an OBJECT ID column 1110, a DOCUMENT NAME column 1120, an ACCESS CONTROL LIST ID column 1130, and a SUPERIORITY RELATIONSHIP INFORMATION ID column 1140. The OBJECT ID column 1110 stores an object ID uniquely identifying an object. The DOCUMENT NAME column 1120 stores a document name of the object (including the name of the object, a folder name, and any other suitable name). The ACCESS CONTROL LIST ID column 1130 stores an access control list ID uniquely identifying an access control list. The SUPERIORITY RELATIONSHIP INFORMATION ID column 1140 stores a superiority relationship information ID uniquely identifying superiority relationship information. The object storage information table 1100 represents the relationship illustrated by way of example in FIG. 6.

FIG. 12 illustrates an example data structure of an access control list 1200. The access control list 1200 is stored in the access control list storage module 160. The access control list 1200 includes an ACCESS CONTROL LIST ID column 1210, an ENTITY column 1220, and a RIGHT column 1230. The ACCESS CONTROL LIST ID column 1210 stores an access control list ID uniquely identifying an access control list. The ENTITY column 1220 stores a user ID or group ID uniquely identifying a user (an individual user or group) granted an access right. The RIGHT column 1230 stores the type of the access right.

FIG. 13 illustrates an example data structure of a superiority relationship information table 1300. The superiority relationship information table 1300 is stored in the superiority relationship information storage module 145. The superiority relationship information table 1300 includes a SUPERIORITY RELATIONSHIP ID column 1310, a SUPERIOR column 1320, and a SUBORDINATE column 1330. The SUPERIORITY RELATIONSHIP ID column 1310 stores a superiority relationship ID uniquely identifying a superiority relationship. The SUPERIOR column 1320 stores a user ID or group ID uniquely identifying a superior user (the grantor of an access right) in the superiority relationship. The SUBORDINATE column 1330 stores a user ID or group ID uniquely identifying a subordinate user (the grantee of an access right) in the superiority relationship.

The superiority relationship information table 1300 is generated when the operation of granting an access right is performed. That is, the superiority relationship information table 1300 may be generated through steps 2 to 7 in the operation history table 800 illustrated by way of example in FIG. 8. For example, when “Sato” (User-1) grants the write right and the read right to Group-1 (step 2 in the operation history table 800), the relationship in the first row of the superiority relationship information table 1300 (superior: “User-1” (grantor: “Sato”), subordinate: “Group-1” (grantee)) is generated. Further, when “Saito” (User-10) grants the read right to “Yamada” (User-13), “Sasaki” (User-14), and “Yamaguchi” (User-15) (step 8 in the operation history table 800), the relationship in the seventh row of the superiority relationship information table 1300 (superior: “User-10” (grantor: “Saito”), subordinate: “User-13” (grantee: “Yamada”)), the relationship in the eighth row of the superiority relationship information table 1300 (superior: “User-10” (grantor: “Saito”), subordinate: “User-14” (grantee: “Sasaki”)), and the relationship in the ninth row of the superiority relationship information table 1300 (superior: “User-10” (grantor: “Saito”), subordinate: “User-15” (grantee: “Yamaguchi”)) are generated.

For example, an example of the control of change of access rights for the product development folder is as follows. The access rights are changed in accordance with the flowchart illustrated by way of example in FIG. 4. If an access right changer is superior in the superiority relationship to an access right changee, it is determined that the changer is permitted to change the access right. Otherwise (if an access right changer is subordinate in the superiority relationship to or has no superiority relationship with an access right changee), it is determined that the changer is not permitted to change the access right.

(1) Case where “Sato” (User-1) superior to “Nakamura” (User-8) wishes to change the access right of “Nakamura”

1-1. Referring to the superiority relationship information, the user/group superior to the access right changee User-8 is User-7.
1-2. User-7 does not match the access right changer User-1.
1-3. Referring to the superiority relationship information, the user/group superior to User-7 is User-4.
1-4. User-4 does not match the access right changer User-1.
1-5. Referring to the superiority relationship information, the user/group superior to User-4 is User-1.
1-6. User-1 matches the access right changer User-1.
1-7. The access right is changed.

### 1-8. End.

Therefore, “Sato” superior to “Nakamura” is permitted to change the access right of “Nakamura”.

(2) Case where “Yamamoto” (User-7) subordinate to “Sato” (User-1) wishes to change the access right of “Sato”

2-1. Referring to the superiority relationship information, no user/group superior to the access right changee User-1 exists.

### 2-2. End.

Therefore, “Yamamoto” subordinate to “Sato” is not permitted to change the access right of “Sato”.

(3) Case where “Yamamoto” (User-7) having no superiority relationship with “Sasaki” (User-14) wishes to change the access right of “Sasaki”

3-1. Referring to the superiority relationship information, the user/group superior to the access right changee User-14 is User-10.
3-2. User-10 does not match the access right changer User-7.
3-3. Referring to the superiority relationship information, the user/group superior to User-10 is User-4.
3-4. User-4 does not match the access right changer User-7.
3-5. Referring to the superiority relationship information, the user/group superior to User-4 is User-1.
3-6. User-1 does not match the access right changer User-7.
3-7. Referring to the superiority relationship information, no user/group superior to User-1 exists.

### 3-8. End.

Therefore, “Yamamoto” having no superiority relationship with “Sasaki” is not permitted to change the access right of “Sasaki”.

<2> A description will be given of a case where when an existing access right is to be changed, superiority relationship information is created from the access control list change history storage module 165 and the superiority relationship is determined.

FIG. 14 illustrates an example data structure of an object storage information table 1400. The object storage information table 1400 is stored in the object storage module 115. The object storage information table 1400 includes an OBJECT ID column 1410, a DOCUMENT NAME column 1420, and an ACCESS CONTROL LIST ID column 1430. The OBJECT ID column 1410 stores an object ID uniquely identifying an object. The DOCUMENT NAME column 1420 stores a document name of the object. The ACCESS CONTROL LIST ID column 1430 stores an access control list ID uniquely identifying an access control list. The object storage information table 1400 represents the relationships illustrated by way of example in FIG. 7.

FIG. 15 illustrates an example data structure of an access control list change history table 1500. The access control list change history table 1500 is stored in the access control list change history storage module 165. The access control list change history table 1500 includes an ACCESS CONTROL LIST CHANGE HISTORY ID column 1510, an CHANGER column 1520, an ACCESS CONTROL LIST ID column 1530, a CHANGEE column 1540, and a CONTENT OF CHANGES column 1550. The ACCESS CONTROL LIST CHANGE HISTORY ID column 1510 stores an access control list change history ID uniquely identifying a history of changes made to an access control list. The CHANGER column 1520 stores a user ID uniquely identifying a user who has changed (or has granted) an access right. The ACCESS CONTROL LIST ID column 1530 stores an access control list ID uniquely identifying an access control list. The CHANGEE column 1540 stores a user ID or group ID of a user whose access right has been changed (or who has been granted the access right). The CONTENT OF CHANGES column 1550 stores the content of changes made to the access right (or the content of the granted access right).

The superiority relationship information (superiority relationship information table 1300) is created from the access control list change history table 1500 of the product development folder in the following manner.

(1) A change history of granting a new access right is obtained from the access control list change history table 1500 of the access right associated with the product development folder. Specifically, rows of the ACCESS CONTROL LIST ID column 1530 in the access control list change history table 1500 corresponding to an access control list ID in the ACCESS CONTROL LIST ID column 1430 in the object storage information table 1400 are obtained, and rows representing the grant of access rights are obtained. In the example of the access control list change history table 1500, all the rows are obtained.
(2) An access right changer and changee are obtained from a change history of granting a new access right. Specifically, an access right changer and changee are obtained from the CHANGER column 1520 and the CHANGES column 1540 in the rows obtained in the above operation (1) in the access control list change history table 1500.
(3) Since the access right changer and changee are identical to the access right grantor and grantee, respectively, superiority relationship information (the superiority relationship information table 1300 illustrated by way of example in FIG. 13) including access right changers and changees is generated.

In other words, the superiority relationship information of the superiority relationship information table 1300 illustrated by way of example in FIG. 13 is obtained from the object storage information table 1400 illustrated by way of example in FIG. 14 and the access control list change history table 1500 illustrated by way of example in FIG. 15. The control of change of the access rights is substantially equivalent to that in item <1> given above.

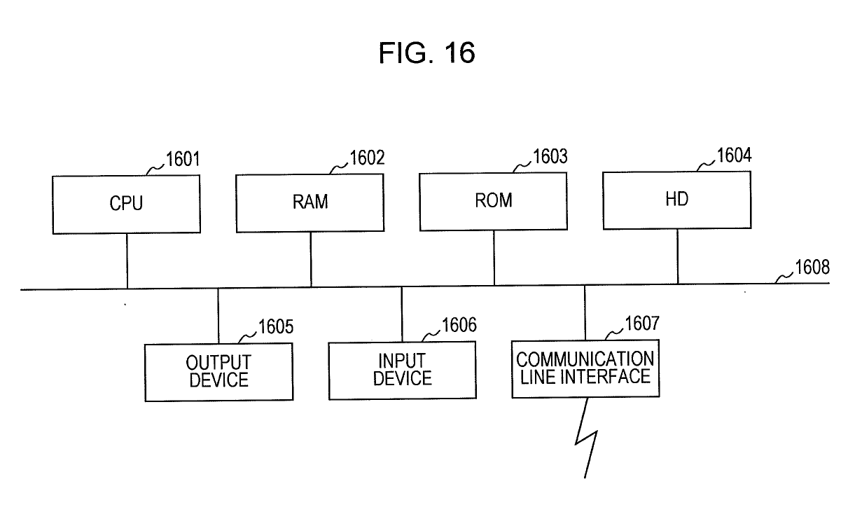

As illustrated by way of example in FIG. 16, which illustrates a hardware configuration, a computer that executes a program according to this exemplary embodiment may be a general computer, and may be specifically a personal computer, a computer capable of serving as a server, or the like. That is, as a specific example, a central processing unit (CPU) 1601 may be used as a processing unit (arithmetic unit), and a random access memory (RAM) 1602, a read-only (ROM) 1603, and a hard disk (HD) 1604 may be used as storage devices. For example, a hard disk may be used as the HD 1604. The computer includes the CPU 1601 that executes a program implementing the access control list changing module 120, the access control list change right determination module 125, the access control list change content determination module 130, the superiority relationship information generation-A module 135, the superiority relationship information generation-B module 140, the superiority relationship determination module 150, the access control list change processing module 155, and the like; the RAM 1602 that stores the program and data, the ROM 1603 that stores a program for booting the computer, and any other suitable item; the HD 1604 that serves as an auxiliary storage device; an input device 1606 configured to input data, such as a keyboard and a mouse; an output device 1605 such as a cathode-ray tube (CRT) or a liquid crystal display; a communication line interface 1607 for connecting to a communication network, such as a network interface card; and a bus 1608 through which the above components are connected to one another to exchange data. Multiple computers each having the above configuration may also be connected to one another via a network.

In the foregoing exemplary embodiment, elements based on a computer program may be implemented by causing a system having the above hardware configuration to read the computer program and allowing software and hardware resources to cooperate with each other.

The hardware configuration illustrated in FIG. 16 is merely an example configuration, and this exemplary embodiment is not limited to the configuration illustrated in FIG. 16 so long as to be capable of executing the modules described in the exemplary embodiment. For example, some modules may be configured using dedicated hardware (such as an application specific IC (ASIC)), and other modules may be provided in an external system and may be connected via a communication line. Alternatively, multiple systems each having the configuration illustrated in FIG. 16 may be connected to one another via a communication line and may operate in association with one another. Furthermore, the system illustrated in FIG. 16 may be incorporated in, in particular, a personal computer, a home information appliance, a copier, a facsimile machine, a scanner, a printer, a multifunctional device (an image processing apparatus having at least two of functions such as scanner, printer, copier, and facsimile functions), or the like.

In this exemplary embodiment, the superiority relationship determination module 150 performs control to determine whether or not to permit a user to change an access right when, by way of example, a subordinate user in superiority relationship information wishes to change the access right of a superior user. The superiority relationship determination module 150 may detect a user who repeatedly attempts to change an access right the user is not granted to change, regardless of whether such events are caused by intentional malicious behavior or simple mistakes.

That is, “success or failure of access right change”, which may be determined by the superiority relationship determination module 150, may be stored in the access control list change history storage module 165. For example, the user ID of an access right changer, the user ID or group ID of an access right changee, the date and time of the changes made to the access right, the success or failure of the access right change, and any other suitable items may be stored. More specifically, a “success or failure of access right change” column may be added to the access control list change history table 1500 illustrated by way of example in FIG. 15.

When the operation of changing an existing access right is performed, for example, the superiority relationship determination module 150 may perform an additional process for determining whether or not the access control list change history table 1500 regarding the access right changer satisfies a predetermined condition (for example, the superiority relationship determination module 150 determines whether the access right changer has failed to delete an access control list change right of a predetermined user a predetermined number of times or more within a predetermined period of time).

Then, the superiority relationship determination module 150 may detect a user satisfying the above condition (a user who wishes to make changes to an access control list the user is not granted to make changes to), and may perform a process such as locking or revoking the access control list change right of the user.

A program described herein may be provided in the form of being stored in a recording medium, or may be provided via a communication medium. In this case, for example, a computer readable medium storing the program described above may constitute an exemplary embodiment of the present invention.

The computer readable recording medium may be a computer readable recording medium storing a program, which is used for installation, execution, distribution, or the like of the program.

Examples of the recording medium include digital versatile discs (DVDs) including discs complying with a DVD Forum standard, such as DVD-Recordable (DVD-R), DVD-Rewritable (DVD-RW), and DVD-RAM discs, and discs complying with a format supported by the DVD+RW Alliance, such as DVD+R and DVD+RW discs, compact discs (CDs) including compact disc read-only memory (CD-ROM), CD-Recordable (CD-R), and CD-Rewritable (CD-RW) discs, a Blu-ray Disc (registered trademark), a magneto-optical (MO) disk, a flexible disk (FD), a magnetic tape, a hard disk, a ROM, an electrically erasable programmable read-only memory (EEPROM), a flash memory, and a RAM.

The above program or a portion thereof may be recorded in any of the above recording media for saving, distribution, or the like, or may be transmitted via communication using a transmission medium such as a wired network used for a local area network (LAN), a metropolitan area network (MAN), a wide area network (WAN), the Internet, an intranet, an extranet, and the like, a wireless communication network, or a combination thereof, or carried on a carrier.

Furthermore, the program described above may be a part of another program, or may be recorded on a recording medium together with a different program. The program may also be recorded separately on plural recording media. The program may also be recorded in any form being capable of recovered such as compressed or encoded.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A computer readable medium storing a program for controlling access to electronically stored information, the program causing a computer to execute a process comprising:
receiving first user information indicating a first user who performs an operation of changing an access right, second user information indicating a second user having the access right to be changed, and operation information indicating the operation of changing the access right;
extracting, from access right grantor/grantee correspondence information stored in a storage device, grantor information corresponding to grantee information representing the received second user information, the access right grantor/grantee correspondence information being information in which grantor information indicating a grantor who has granted an access right to perform an operation on information is related to grantee information indicating a grantee granted the access right by the grantor;
determining whether or not the extracted grantor information represents the received first user information; and
performing a process for changing the access right indicated by the received operation information if it is determined that the extracted grantor information represents the received first user information.

2. The computer readable medium according to claim 1, wherein the access right grantor/grantee correspondence information includes a plurality of correspondences between grantors and grantees, and
wherein in the extracting, if it is determined that the extracted grantor information does not represent the received first user information, grantor information corresponding to grantee information related to previously extracted grantor information is extracted from the access right grantor/grantee correspondence information.

3. The computer readable medium according to claim 1, wherein the process further comprises
receiving third user information indicating a third user who performs an operation of granting an access right, fourth user information indicating a fourth user who is granted the access right, and operation information indicating the operation of granting the access right; and
generating the access right grantor/grantee correspondence information using the received third user information as the grantor information and using the received fourth user information as the grantee information.

4. The computer readable medium according to claim 2, wherein the process further comprises
receiving third user information indicating a third user who performs an operation of granting an access right, fourth user information indicating a fourth user who is granted the access right, and operation information indicating the operation of granting the access right; and
generating the access right grantor/grantee correspondence information using the received third user information as the grantor information and using the received fourth user information as the grantee information.

5. The computer readable medium according to claim 1, wherein the process further comprises
generating the access right grantor/grantee correspondence information from history information stored in the storage device, the history information including a history of a previously granted access right and being information in which third user information indicating a third user who has set an access right and fourth user information indicating a fourth user who has been granted the access right by the third user are related to each other, using the third user information in the history information as the grantor information and using the fourth user information in the history information as the grantee information.

6. The computer readable medium according to claim 2, wherein the process further comprises
generating the access right grantor/grantee correspondence information from history information stored in the storage device, the history information including a history of a previously granted access right and being information in which third user information indicating a third user who has set an access right and fourth user information indicating a fourth user who has been granted the access right by the third user are related to each other, using the third user information in the history information as the grantor information and using the fourth user information in the history information as the grantee information.

7. An information processing apparatus for controlling access to electronically stored information, comprising:
a change operation receiving unit that receives first user information indicating a first user who performs an operation of changing an access right, second user information indicating a second user having the access right to be changed, and operation information indicating the operation of changing the access right;
an extraction unit that extracts, from access right grantor/grantee correspondence information stored in a storage device, grantor information corresponding to grantee information representing the second user information received by the change operation receiving unit, the access right grantor/grantee correspondence information being information in which grantor information indicating a grantor who has granted an access right to perform an operation on information is related to grantee information indicating a grantee granted the access right by the grantor;
a determination unit that determines whether or not the grantor information extracted by the extraction unit represents the first user information received by the change operation receiving unit; and
an access right changing unit that performs a process for changing the access right indicated by the received operation information if the determination unit determines that the extracted grantor information represents the first user information received by the change operation receiving unit.

8. A method for controlling access to electronically stored information, comprising:
receiving first user information indicating a first user who performs an operation of changing an access right, second user information indicating a second user having the access right to be changed, and operation information indicating the operation of changing the access right;
extracting, from access right grantor/grantee correspondence information stored in a storage device, grantor information corresponding to grantee information representing the received second user information, the access right grantor/grantee correspondence information being information in which grantor information indicating a grantor who has granted an access right to perform an operation on information is related to grantee information indicating a grantee granted the access right by the grantor;
determining whether or not the extracted grantor information represents the received first user information; and
performing a process for changing the access right indicated by the received operation information if it is determined that the extracted grantor information represents the received first user information.
